(19) United States
(12) Patent Application Publication
(10) Pub. No.: US 2026/0320510 A1
(43) Pub. Date: Oct. 15, 2026

(54) METHOD AND SYSTEM FOR ADAPTIVE PRIORITISATION OF SERVICE CASE TO ACCOUNT CHANGING ENVIRONMENT AND EQUIPMENT PARAMETERS, FAULT CONDITIONS, ECONOMIC AND OPERATIONAL

(71) Applicant: Honeywell International Inc., Charlotte, NC (US)

(72) Inventors: Chaithrika Rao, Bangalore (IN); Karthika M, Bangalore (IN); Boon Toh, Toorak Gardens (AU); Jiri Rojicek, Praha (HR); Balakrishnan P, Kariapatti (IN); Naveen Prabhu, Sagar (IN); Sarath Sasidharan, Bangalore (IN)

(21) Appl. No.: 19/177,675

(22) Filed: Apr. 14, 2025

(51) Int. Cl. G06Q 10/0631; G06Q 10/20; G06Q 50/10

(52) U.S. Cl. CPC G06Q 10/0631; G06Q 10/20; G06Q 50/10

(57) ABSTRACT

The present disclosure provides techniques for prioritizing service case requests in a building management system. In an embodiment, techniques are provided for prioritizing the service case requests based on one or more parameters associated with each service case request. In an embodiment, the one or more parameters associated with the one or more service case requests include at least one of: case status, fault last seen, fault duration, fault occurrence, fault last reopened, cost, rule priority, asset priority, impacted space priority of the one or more service case requests. Further each of these parameters are associated with defined weightage which determines the contribution of these parameters into deriving the final priority score. In an embodiment, the priority score against each service case request is determined by considering, the set of parameter values and weightage as defined by system. The weights of the one or more parameters of the service case requests reflect the relative importance of the parameters to each service case request. The present disclosure provides a prioritizing system wherein the plurality of the service case requests received from the one or more industrial plants of an enterprise are prioritized based on the one or more parameters of the service case requests and to perform one or more operations on an asset based on prioritization.

### TECHNICAL FIELD

Embodiments of the present disclosure generally relate to building management system. Particularly, the present disclosure relates to a method and system for prioritizing service case requests in a building management system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Typically, business enterprises implement a building management system to integrate various facilities and services to enhance operational efficiency, comfort, and safety. The management of building services such as heating, ventilation, air conditioning (HVAC), power systems, networking and security are automated by the existing building management systems and the algorithm runs periodically to check the health and operation of these services. Once an error or a fault in an asset is detected, service case request (job card/ticket) is created to inform the end user to take adequate steps to perform corrective action.

Existing building management systems for prioritizing service case requests typically rely upon threshold-based rule engine for assigning priority to a service case request. However, these approaches usually have an inherent disadvantage in that, the rule engine works based on static factors, though these requests have multiple static and dynamic factors. Further, traditional way of assigning priority to service case requests which is rule based and static in nature throughout the life cycle of service case request is not able to articulate the order in which service technicians should focus their effort during day-to-day site operations. In other words, the traditional system of assigning priority to service case requests is unable to utilize the labor effort efficiently resulting in increased operational cost. Also, as critical issues are not addressed on priority basis, it is resulting in reduced asset life cycle.

Accordingly, there is a need for technical solutions to address the technical problems discussed above, and other inefficiencies of the prior arts. Particularly, there is a need for a prioritization system and a method thereof that streamlines the service case request prioritization and enhances revenue realization for business enterprises.

The legacy approaches fail to provide efficient techniques for prioritizing service case requests, that not only enhances the operational efficiency of the prioritization system but also utilizes labor effort efficiently and reduces operational cost.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure relate to prioritizing service case requests in a building management system. Other implementations will be, or will become, apparent to one with skill in the art upon examination of the following figures and detailed description. It is intended that all such additional implementations be included within this description be within the scope of the disclosure and be protected within the scope of the following claims.

The present disclosure provides techniques for prioritizing service case requests in a building management system. In an embodiment, techniques are provided for prioritizing the service case requests based on one or more parameters associated with each service case request. In an embodiment, the one or more parameters associated with the one or more service case requests include at least one of: case status, fault last seen, fault duration, fault occurrence, fault last reopened, cost, rule priority, asset priority, impacted space priority of the one or more service case requests. Further each of these parameters are associated with defined weightage which determines the contribution of these parameters into deriving the final priority score. In an embodiment, the priority score against each service case request is determined by considering, the set of parameter values and weightage as defined by system. The weights of the one or more parameters of the service case requests reflect the relative importance of the parameters to each service case request. The present disclosure provides a prioritizing system wherein the plurality of the service case requests received from the one or more industrial plants of an enterprise are prioritized based on the one or more parameters of the service case requests and to perform one or more operations on an asset based on prioritization. The one or more operations performed on the asset may be not limited to: repair or replacement of faulty components, adjustment of system settings, maintenance or calibration, software updates or patches, inspection and testing, emergency services, scheduling of maintenance, etc.

In another embodiment, the present disclosure provides a method for prioritizing service case requests for performing one or more operations on an asset in a prioritization system based on one or more parameters associated with each service case request. The method comprises receiving one or more service case requests. The method further comprises extracting one or more parameters associated with the service case request, wherein each parameter of the one or more parameters has an associated weight and wherein the one or more parameters associated with the one or more service case requests include at least one of: case status, fault last seen, fault duration, fault occurrence, fault last reopened, cost, rule priority, asset priority, impacted space priority of the one or more service case requests. The method further comprises grouping the one or more parameters into one or more sets, wherein each set of the one or more sets consists of mutually dependent parameters. The method further comprises adjusting the weight of each parameter based on category and severity contribution of each parameter. The method further comprises calculating a score for each parameter of the one or more parameters in each set based on associated weight and adjusted weight. The method further comprises calculating a priority score for each set based on the adjusted weight and the score of each parameter of the one or more parameters in the set. The method further comprises calculating an overall priority score of the service case request based on the priority score for each set. The method further comprises ranking the one or more service case requests based on the overall priority score. The method further comprises prioritizing the one or more service case requests based on the rank. The method further comprises performing one or more operations on an asset based on prioritization.

In an aspect, the method further comprises determining the severity contribution of each parameter based on its impact on the overall priority score of each service case request, wherein the category of the one or more parameters is static or dynamic. In an aspect, the method further comprises updating the overall priority score of the one or more service case requests at scheduled intervals based on one or more dynamic parameters. In an aspect, the method further comprises updating the rank of the one or more service case requests based on the overall priority score. In an aspect, the method further comprises prioritizing the one or more service case requests based on the updated rank. In an aspect, the method further comprises displaying the overall priority score of the one or more service case requests to a user. In an aspect, the method further comprises manually updating priority of the one or more service case requests.

In another embodiment, the present disclosure provides a system for prioritizing one or more service case requests based on one or more parameters associated with each service case request, the system comprising a processor and a memory storing program instructions which, when executed by the processor, causes the processor to receive one or more service case requests. The processor is further configured to extract one or more parameters associated with the service case request, wherein each parameter of the one or more parameters has an associated weight and wherein the one or more parameters associated with the one or more service case requests include at least one of: case status, fault last seen, fault duration, fault occurrence, fault last reopened, cost, rule priority, asset priority, impacted space priority of the one or more service case requests. The processor is further configured to group the one or more parameters into one or more sets, wherein each set of the one or more sets consists of mutually dependent parameters. The processor is further configured to adjust the weight of each parameter based on category and severity contribution of each parameter. The processor is further configured to calculate a score for each parameter of the one or more parameters in each set based on associated weight and adjusted weight. The processor is further configured to calculate a priority score for each set based on the adjusted weight and the score of each parameter of the one or more parameters in the set. The processor is further configured to calculate an overall priority score of the service case request based on the priority score for each set. The processor is further configured to rank the one or more service case requests based on the overall priority score. The processor is further configured to prioritize the one or more service case requests based on the rank. The processor is further configured to perform one or more operations on an asset based on prioritization.

In an aspect, the processor may be further configured to determine the severity contribution of each parameter based on its impact on the overall priority score of each service case request, wherein the category of the one or more parameters is static or dynamic. In an aspect, the processor may be further configured to update the overall priority score of the one or more service case requests at scheduled intervals based on one or more dynamic parameters. In an aspect, the processor may be further configured to update the rank of the one or more service case requests based on the overall priority score. In an aspect, the processor may be further configured to prioritize the one or more service case requests based on the updated rank. In an aspect, the processor may be further configured to display the overall priority score of the one or more service case requests to a user.

In yet another embodiment, the present disclosure provides a non-transitory computer-readable storage medium, storing program instructions executed by a processor for prioritizing service case requests for performing one or more operations on an asset in a prioritization system based on one or more parameters associated with each service case request. The program instructions when executed by the processor, receives one or more service case requests. The program instructions when executed by the processor, extracts one or more parameters associated with the service case request, wherein each parameter of the one or more parameters has an associated weight and wherein the one or more parameters associated with the one or more service case requests include at least one of: case status, fault last seen, fault duration, fault occurrence, fault last reopened, cost, rule priority, asset priority, impacted space priority of the one or more service case requests. The program instructions when executed by the processor, groups the one or more parameters into one or more sets, wherein each set of the one or more sets consists of mutually dependent parameters. The program instructions when executed by the processor, adjusts the weight of each parameter based on category and severity contribution of each parameter. The program instructions when executed by the processor, calculates a score for each parameter of the one or more parameters in each set based on associated weight and adjusted weight. The program instructions when executed by the processor, calculates a priority score for each set based on the adjusted weight and the score of each parameter of the one or more parameters in the set. The program instructions when executed by the processor, calculates an overall priority score of the service case request based on the priority score for each set. The program instructions when executed by the processor, ranks the one or more service case requests based on the overall priority score. The program instructions when executed by the processor, prioritizes the one or more service case requests based on the rank for operation. The program instructions when executed by the processor, perform one or more operations on an asset based on prioritization.

In an aspect, the program instructions when executed by the processor, determines the severity contribution of each parameter based on its impact on the overall priority score of each service case request, wherein the category of the one or more parameters is static or dynamic. In an aspect, the program instructions when executed by the processor, updates the overall priority score of the one or more service case requests at scheduled intervals based on one or more dynamic parameters. In an aspect the program instructions when executed by the processor, updates the rank of the one or more service case requests based on the overall priority score. In an aspect, the program instructions when executed by the processor, prioritizes the one or more service case requests based on the updated rank. In an aspect, the program instructions when executed by the processor, displays the overall priority score of the one or more service case requests to a user.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary general architecture of a prioritization system implemented in an industrial plant of a business enterprise in accordance with one or more embodiments described herein;

FIG. 3 illustrates a detailed block diagram for prioritizing service case requests, in accordance with one or more embodiments described herein;

FIG. 4 illustrates an exemplary block diagram of a system for prioritizing service case requests, in accordance with one or more embodiments described herein;

FIG. 5 illustrates a general block diagram of an exemplary computing system for prioritizing service case requests in accordance with one or more embodiments described herein;

FIG. 6 illustrates a flow diagram of a method for prioritizing service case requests in accordance with one or more embodiments described herein;

FIG. 7A illustrates an exemplary tabular representation showing the change in the prioritization of a service case request, in accordance with one or more embodiments described herein;

FIG. 7B illustrates an exemplary graphical representation of change in prioritization of a service case request (based on FIG. 7A), in accordance with one or more embodiments described herein;

FIG. 8A illustrates another exemplary tabular representation showing the change in the prioritization of a service case request, in accordance with one or more embodiments described herein;

FIG. 8B illustrates another exemplary graphical representation of change in prioritization of a service case request (based on FIG. 8A), in accordance with one or more embodiments described herein;

FIG. 9A illustrates another exemplary tabular representation showing the change in the prioritization of a service case request, in accordance with one or more embodiments described herein;

FIG. 9B illustrates another exemplary graphical representation of change in prioritization of a service case request (based on FIG. 9A), in accordance with one or more embodiments described herein;

FIG. 10 illustrates an exemplary dashboard layout, in accordance with one or more embodiments described herein;

FIG. 11 illustrates another exemplary dashboard layout, in accordance with one or more embodiments described herein;

FIG. 12 illustrates another exemplary dashboard layout, in accordance with one or more embodiments described herein;

FIG. 13 illustrates another exemplary dashboard layout, in accordance with one or more embodiments described herein; and

FIG. 14 illustrates another exemplary dashboard layout, in accordance with one or more embodiments described herein.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

The aim of this present disclosure is to provide a prioritization system and method that provides a custom solution to prioritize service case requests of one or more industrial plants of an enterprise rather than a static approach to queue the service case requests to operation. The advantage of having a custom solution is that it adapts to provide the fastest, lowest cost solution to derive the service case request priority based on multiple static and dynamic factors and then continuously tuning it by considering the various dynamic parameters affecting the site operations. To this end, the present disclosure considers several static and dynamic parameters of the service case request and the asset on which the request is raised and calculates a priority score which is further used to derive the service case request priority as Critical, High, Medium, Low. Further, each of these parameters is associated with defined weightage which determines the contribution of these parameters into deriving the final priority score of the service case request. The objective of the present disclosure is to optimize labor effort and operational costs and to improve asset life cycle.

The solution proposed by the present disclosure provides a technique wherein, instead of prioritizing service case requests by a threshold-based static rule engine, the service case requests are prioritized and displayed in the service case request dashboards by employing a priority score function, which is dynamic and prioritizes the service case requests by considering several static and dynamic factors.

The priority score function enables dynamically prioritizing service case requests unlike in the prior arts, which is rule based. The priority score function may be implemented as a middleware component of a building management system or user interface, as a standalone application, or as an on-demand or hosted service.

Embodiments of the present disclosure generally describe non-conventional approaches to systems and methods for prioritizing one or more service case requests based on one or more parameters associated with each service case request. The embodiments of the present disclosure described herein aims to optimize the overall operation of the system by considering the labor effort and cost as this disclosure would help in getting the focused worklist based on dynamic parameters and also increases the asset life cycle. The disclosure herein describes embodiments that enhances the revenue realization of the building management systems by providing a custom solution for prioritizing service case requests that effectively manages service case requests received from the one or more industrial plants of an enterprise.

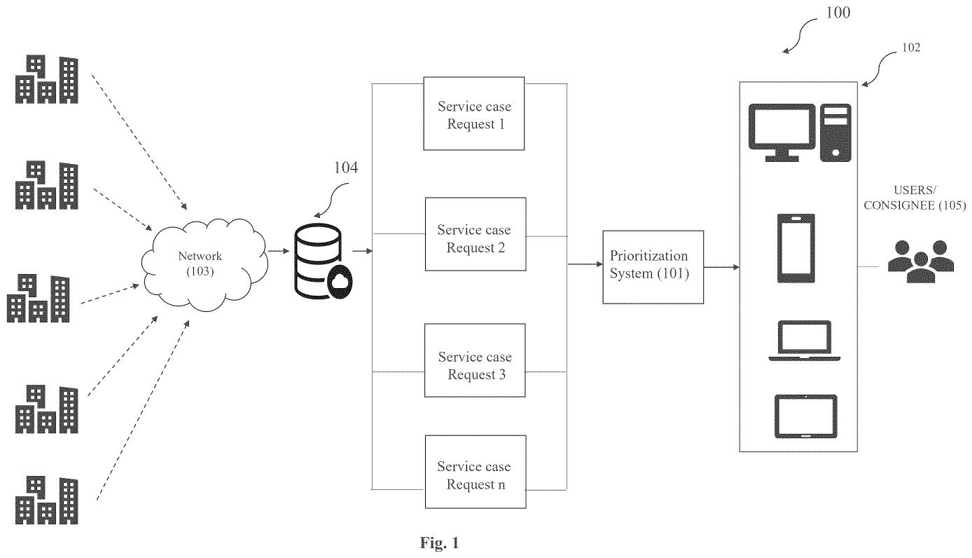

FIG. 1 illustrates an exemplary block diagram of an environment 100, in which the embodiments of the present disclosure may operate. FIG. 1 illustrates configuration of a system for prioritizing service case requests of one or more industrial plants of an enterprise. In such embodiments, a prioritization system 101 acts as an intermediary mechanism between a database 104 of the one or more industrial plants of the enterprise and users/consignee 102, and is used for prioritising service case request for performing one or more operations on an asset of the one or more industrial plants of the enterprise.

According to an embodiment, the database 104 may be implemented in the system 101 or virtually implemented in a cloud server. According to the example environment 100 as depicted in FIG. 1, the database 104 is virtually implemented in the cloud server. According to an embodiment, the database 104 includes information related to the health and operation of the various assets of the one or more industrial plants of the enterprise. The database 104 stores key details that help with tracking, managing, and maintaining these assets effectively throughout their lifecycle. In a non-limiting example, the information may include an equipment identification information, acquisition details, operational and usage information, maintenance and repair information, financial and depreciation information, legal, compliance, and safety Information, condition and performance information, lifecycle and End-of-Life information, asset tracking and security, vendor and support Information.

According to a further embodiment, the system 101 is operatively coupled with the database 104 for fetching the information related to the various assets of the one or more industrial plants of the enterprise.

Herein, the system 101 may be configured to prioritize service case requests of industrial plants of an enterprise. The system 101 receives one or more service case requests from the entity database 107 of the enterprise. The system 101 extracts one or more parameters associated with the service case request, wherein each parameter of the one or more parameters has an associated weight. The one or more parameters associated with the one or more service case requests include at least one of: case status, fault last seen, fault duration, fault occurrence, fault last reopened, cost, rule priority, asset priority, impacted space priority of the one or more service case requests and the category of these parameters is either static or dynamic. Further each of these parameters are associated with defined weightage which determines the contribution of these parameters into deriving the final priority score. The system 101 considers several static and dynamic parameters of the service case request and the asset on which the request is raised and calculates a priority score which is further used to derive the service case priority as Critical, High, Medium, Low. Further, the system 101 evaluates the dynamically modifying parameters and adjusts the priority score periodically against each service case request so that the service case request ranking is adjusted to show the critical items on top of the list for operational purposes. The system 101 displays the priority score of the service case requests sorted in ascending to descending order in the client devices 102 of the one or more users 105 with highest priority service case request available on top of the list. As the priority score is dynamic in nature, the system 101 updates the list periodically. Service case priority may also be edited manually by the one or more users 105. However, as the priority score is fine-tuned by the system 101 based on the dynamic parameters mentioned above at scheduled intervals upon refresh of the portal, the updated list of the prioritized service case requests will be displayed in the client devices 102 of the one or more users 105.

Table 1 illustrates an example of static and dynamic parameters of the service case requests and its associated weight and its contribution to derive priority score.

TABLE 1

| Nature of | | | |
|---|---|---|---|
| Criteria | Parameters | Contribution | Weightage |
| Dynamic | Case Status | Identified & In Progress status | 1 |
| Dynamic | Fault Last Seen | Older the fault last seen, lower the score | 1 |
| Dynamic | Fault Duration | Older the fault last seen, lower the score | 0.5 |
| Dynamic | Fault Occurrence | Higher the occurrence higher the score | 0.5 |
| Fixed | Identified Cost | Higher the cost, higher the score | 1 |
| Fixed | Rule Priority | Critical, High, Med, Low | 0.8 |
| Fixed | Asset Priority | Critical, High, Med, Low | 1 |
| Fixed | Impacted Space Priority | Critical, High, Med, Low | 1 |
| Fixed | Parent/Downstream | Target asset is a Parent Asset | 0.8 |
| | asset | (Upstream) have higher priority than | |
| | | Downstream assets | |
| Fixed | Rule Outcome Target | Energy/Gas/Water/Comfort/Operations | 0.6 |
| Fixed | Asset Type Priority | Plant System, AHU, Heat Exchanger, | 0.7 |
| | (Considered if Asset | Pump/VAV/Any other asset. Plant | |
| | Priority is not available) | System have higher priority than other | |
| | | systems | |

Table 2 illustrates an example of service case request priority score mapped to priority.

TABLE 2

| Priority Score | Priority |
|---|---|
| 10 | Critical |
| 7, 8, 9 | High |
| 4, 5, 6 | Medium |
| 1, 2, 3 | Low |

In one or more embodiments, the one or more client devices 102 is integrated within or corresponds to a mobile computing device, a smartphone, a tablet computer, a mobile computer, a desktop computer, a laptop computer, a workstation computer, a wearable device, a virtual reality device, an augmented reality device, or another type of remote computing device. Although exemplary system 100 is shown with four client devices 102, any number of client devices may be supported.

In an embodiment, the plurality of client devices 102 may be operable by one or more users or clients 105 of an enterprise to prioritize service case requests, typically, to achieve a particular business goal or objective. For example, enterprises may include sectors focused on manufacturing and construction, providing services such as retail, healthcare, finance, and transportation), dedicated to knowledge-based services like research, information technology, and education), involving high-level decision-making, specialized services, and non-profit organizations, etc.

According to various embodiments, a network 103 may be configured to provide communication between various components depicted in FIG. 1. In some embodiments, the network 103 may include a public network (e.g., the Internet), (e.g., an internal localized, or closed-off network between particular devices). In some other embodiments, the network 103 may be a hybrid network (e.g., a network enabling internal communications between particular connected devices and external communications with other devices). Such configuration(s) include, without limitation, a wired or wireless Personal Area Network (PAN), a Cloud network, Local Area Network (LAN), Metropolitan Area Network (MAN), Wide Area Network (WAN), and/or the like. In various embodiments, the network 103 may include one or more base station(s), relay(s), router(s), switch(es), routing station(s), and/or the like.

In an embodiment, the plurality of client devices 102 may be utilized by one or more clients or users 105. The users 105 operating one or more client devices 101 may prioritize service case requests received from one or more industrial plants of the enterprise.

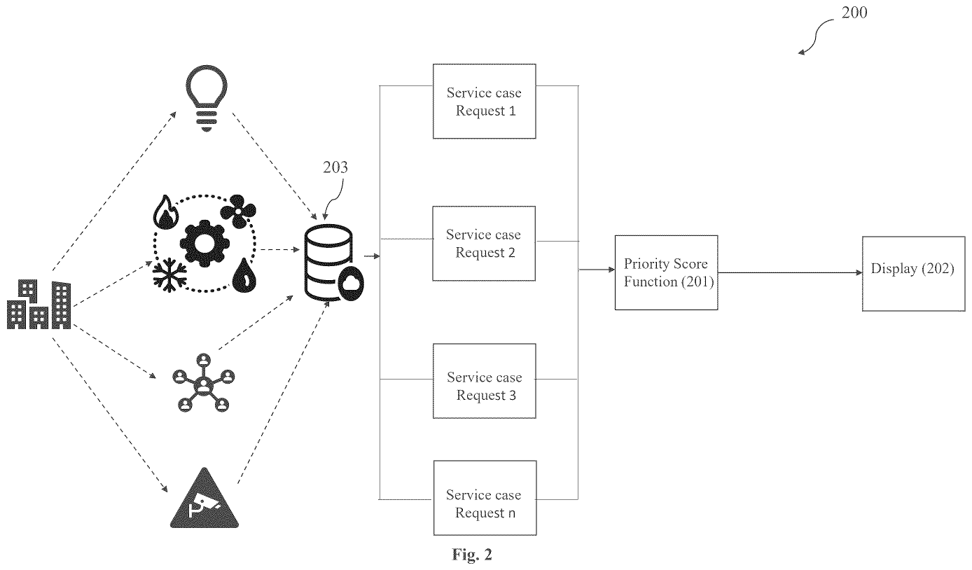

FIG. 2 illustrates an exemplary general architecture of a prioritization system in an industrial plant of a business enterprise, in accordance with one or more embodiments described herein. According to an example embodiment, as depicted in FIG. 2, the prioritization system 200 comprises a priority score function 201 coupled with a display 202. The priority score function 201 is further coupled with a database 203 to receive service case requests from the industrial plant. The system 101 runs an algorithm periodically to check the health and operation of the various assets of the industrial plant. Once an error or a fault in an asset is detected, a service case request (job card/ticket) is created and the same is sent to the priority score function 201. The priority score function 201 extracts one or more parameters associated with the service case request, wherein each parameter of the one or more parameters has an associated weight. The one or more parameters associated with the one or more service case requests include at least one of: case status, fault last seen, fault duration, fault occurrence, fault last reopened, cost, rule priority, asset priority, impacted space priority of the one or more service case requests and the category of these parameters is either static or dynamic. Further each of these parameters are associated with defined weightage which determines the contribution of these parameters into deriving the final priority score.

The priority score function 201 considers several static and dynamic parameters of the service case request and the asset on which the request is raised and calculates a priority score which is further used to derive the service case priority as Critical, High, Medium, Low. Further, the priority score function 201 evaluates the dynamically modifying parameters and adjusts the priority score periodically against each service case request so that the service case request ranking is adjusted to show the critical items on top of the list for operational purposes. The priority score function 201 displays the priority score of the service case requests sorted in ascending to descending order in the display 202 of the client devices 102 for the one or more users 105 with highest priority service case request available on top of the list. As the priority score is dynamic in nature, the priority score function 201 updates the list periodically.

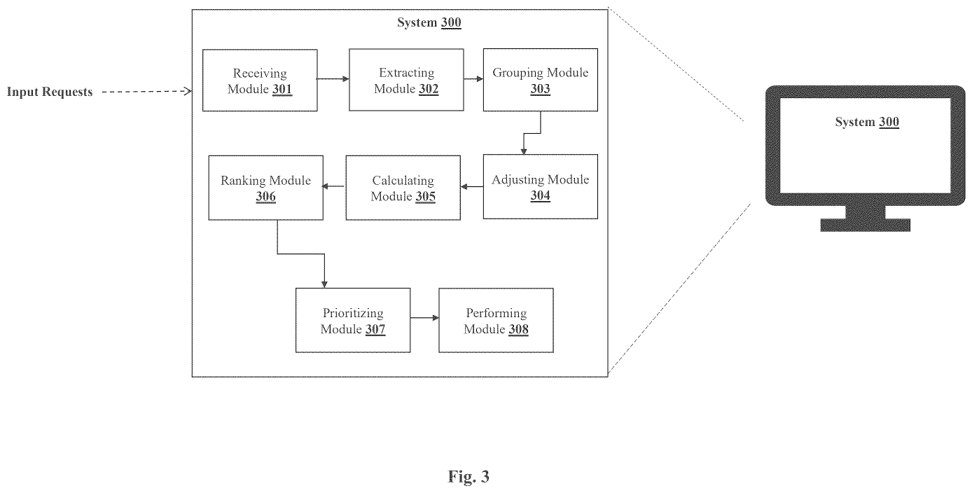

FIG. 3 illustrates a detailed block diagram for prioritizing service case requests in a prioritization system, according to an embodiment of the present disclosure. According to an embodiment, FIG. 3 depicts a system 300 comprising one or more modules for prioritizing service case requests in a prioritization system. In a non-limiting example, the system 300 may be a computer, a laptop, a physical server, a virtual server, a cloud-based server, or any electronic machine. According to an embodiment, the system 300 may be implemented with an application (App) 310. According to an embodiment, the system 300 includes a receiving module 301, an extracting module 302, a grouping module 303, an adjusting module 304, a calculating module 305, a ranking module 306, a prioritizing module 307 and a performing module 308 coupled with each other. According to an embodiment, the receiving module 301, the extracting module 302, the grouping module 303, the adjusting module 304, the calculating module 305, the ranking module 306, the prioritizing module 307 and the performing module 308 are uniquely designed hardware modules or software modules.

According to some embodiments, functions of the receiving module 301, the extracting module 302, the grouping module 303, the adjusting module 304, the calculating module 305, the ranking module 306 and the prioritizing module 307 can be performed by the processor(s). According to some embodiment, the receiving module 301, the extracting module 302, the grouping module 303, the adjusting module 304, the calculating module 305, the ranking module 306, the prioritizing module 307 and the performing module 308 be a part of an AI framework of the application to develop the AI-powered solutions for the specific tasks. Furthermore, the labels depicted in the representative drawings are kept the same for similar components throughout the disclosure for ease of understanding. A detailed explanation of each module will be explained in the forthcoming paragraphs.

According to an embodiment, the receiving module 301 receives the input service case requests for performing the specific task.

According to an embodiment, the extracting module 302 extracts one or more parameters associated with the service case request, wherein each parameter of the one or more parameters has an associated weight. The one or more parameters associated with the one or more service case requests include at least one of: case status, fault last seen, fault duration, fault occurrence, fault last reopened, cost, rule priority, asset priority, impacted space priority of the one or more service case requests and the category of these parameters is either static or dynamic. Further each of these parameters are associated with defined weightage which determines the contribution of these parameters into deriving the final priority score.

According to an embodiment, the grouping module 303 groups the one or more parameters into one or more sets, wherein each set of the one or more sets consists of mutually dependent parameters.

According to an embodiment, the adjusting module 304 determines the severity contribution of each parameter based on its impact on the overall priority score of each service case request, wherein the category of the one or more parameters is static or dynamic. The adjusting module 303 adjusts the weight of each parameter based on category and severity contribution of each parameter.

According to an embodiment, the calculating module 305 calculates a score for each parameter of the one or more parameters in each set based on associated weight and adjusted weight. The calculating module 305 further calculates a priority score for each set based on the adjusted weight and the score of each parameter of the one or more parameters in the set. The calculating module 305 further calculates an overall priority score of the service case request based on the priority score for each set. The calculating module 305 further updates the overall priority score of the one or more service case requests at scheduled intervals based on one or more dynamic parameters.

According to an embodiment, the ranking module 306 ranks the one or more service case requests based on the overall priority score. The ranking module 306 further updates the rank of the one or more service case requests based on the overall priority score.

According to an embodiment, the prioritizing module 307 prioritizes the one or more service case requests based on the rank. The prioritizing module 307 further prioritizes the one or more service case requests based on the updated rank.

According to an embodiment, the performing module 308 performs one or more operations on an asset based on prioritization. The one or more operations performed on the asset may be not limited to: repair or replacement of faulty components, adjustment of system settings, maintenance or calibration, software updates or patches, inspection and testing, emergency services, scheduling of maintenance, etc.

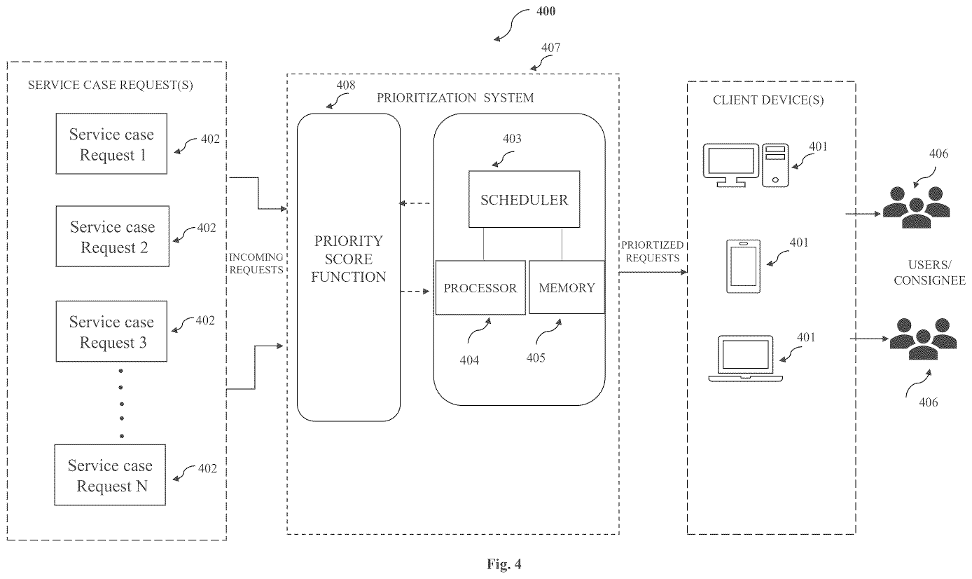

FIG. 4 illustrates an exemplary block diagram of a system 400 for prioritizing service case requests in a prioritization system in accordance with one or more embodiments described herein. In an embodiment, the system 400 may be configured to prioritize service case requests of business enterprises with an aim to provide optimum performance of the system. The system 400 includes a prioritization system 407 comprising a priority score function 408 and a scheduler 403. The prioritization system 407 may also comprise a processor 404 communicably coupled to a memory 405. The processor 404 may store and execute instructions for implementing the functions of the scheduler 303. In an embodiment, the priority score function 408 receives service case requests from a plurality of assets of the enterprise. The prioritized requests from the priority score function 408 are monitored by the scheduler 403 for efficiently updating the priority of the one or more service case requests at scheduled intervals based on one or more dynamic parameters to the one or more users 406 operating one or more client devices 401.

In an embodiment, the prioritization system 407 may include a memory 405 operatively to the processor 404. The memory 405 may be non-transitory and may include, for example, one or more volatile and/or non-volatile memories. In some embodiments, the memory 405 includes or embodies an electronic storage device (e.g., a computer readable storage medium). In some embodiments, the memory 405 is configured to store information, data, content, applications, instructions, or the like, for enabling a system to carry out various operations and/or functions in accordance with example embodiments of the present disclosure.

In one or more embodiments, the system 400 may include one or more software modules or components for prioritizing service case requests of one or more industrial plants of an enterprise in accordance with the one or more embodiments of the present disclosure. In an embodiment, the one or more software modules may include but not limited to the scheduler 403 which implements the functions of the prioritization system 407 through the processor 404.

In one preferred embodiment, the system 100, 200, 300 and 400 of the present disclosure may be configured as a cloud-based system. In various embodiments, the cloud environment may be configured to run one or more services or software applications provided by one or more components of the system 100, 200, 300 and 400. In some embodiments, the services may be offered as web-based or cloud-based services to the users of the client devices 102 and 401. In another embodiment, one or more of the components of system 400 and/or the services provided by the components may also be implemented by one or more client devices 102 and 401. Users operating the client devices 102 and 401 may utilize one or more client applications to use the services provided by the components of the system 100, 200, 300 and 400.

In an embodiment, one or more modules (not shown) of the system 100, 200, 300 and 400 may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.). Although components are described with respect to functional limitations, it should be understood that the particular implementations necessarily include the use of particular computing hardware. It should also be understood that in some embodiments certain of the components described herein include similar or common hardware.

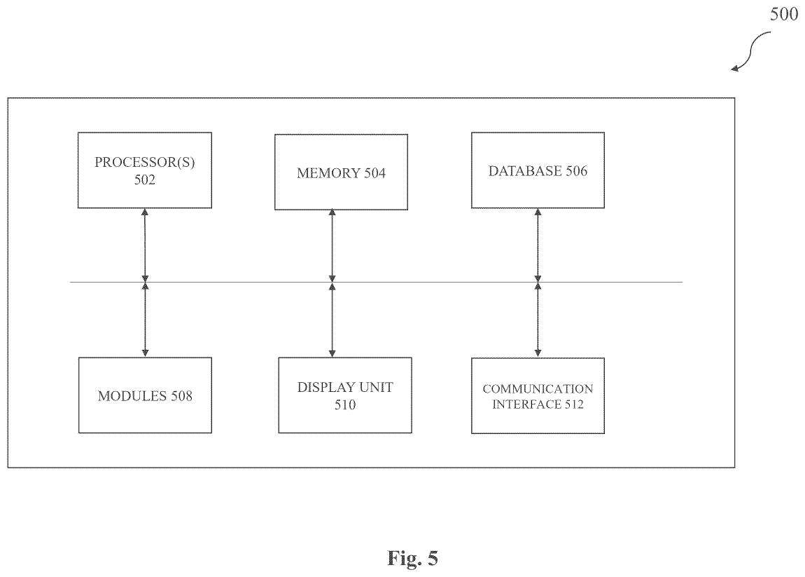

FIG. 5 illustrates a general block diagram of an exemplary computing system 500 used in system 100, 200, 300 and 400 for prioritizing service case requests in accordance with one or more embodiments described herein. The system shown in FIG. 5 may be a prioritization system disclosed in the foregoing embodiments of this present disclosure, and may implement the prioritization system. As shown in FIG. 5, the computing system 500 may include a processor 502, communication interface 512 and memory 504. Optionally, the system 500 may further include database 506, modules 508 and display unit 510. The memory 504 may be disposed inside the apparatus, or may be disposed outside the apparatus.

The computing system 500 includes a processor 502 which may be a single processing unit or a number of units, all of which could include multiple computing units. The processor 502 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 502 is configured to fetch and execute computer-readable instructions and data stored in a memory 504.

The memory 504 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The computing system 500 may comprise a database 506 and may be implemented with integrated hardware and software. The hardware may include a hardware disk controller with programmable search capabilities or a software system running on general-purpose hardware. Examples of databases are but not limited to, in-memory databases, cloud databases, distributed databases, embedded databases, and the like. The database amongst other things, serves as a repository for storing data processed, received, and generated by one or more of the processors 502, and the module(s) 508. In an embodiment, the modules 508 may be implemented with an AI module.

In an example, the computing system 500 may include one or more software modules or components 508 for prioritizing the service case requests based on one or more parameters associated with each service case request. in accordance with the one or more embodiments of the present disclosure. In an embodiment, the one or more software modules 508 may include a program, a subroutine, a portion of a program, a software component or a hardware component capable of performing a stated task or function. As used herein, the modules may be implemented on a hardware component such as a server independently of other modules, or a module can exist with other modules on the same server, or within the same program. The module(s) 508 may be implemented on a hardware component such as processor one or more microprocessors, microcomputers, microcontrollers, digital signal processors, central processing units, state machines, logic circuitries, and/or any devices that manipulate signals based on operational instructions. The module(s) 508 when executed by the processor 502 may be configured to perform any of the described functionalities. Specifically, the module(s) 508 may be configured to implement efficient and flexible prioritization system.

The computing system 500 comprises a display unit 510 that includes a computer monitor, a touch screen, an output device capable of displaying the graphics, and the like. The display unit 510 is configured to display visual output in desktops, laptops, and workstations.

The computing system 500 comprises a communication interface 512 configured to provide and establish communication with any electronic device via a public network, private network, or any wireless communication technology.

For example, actions performed by the prioritization system in FIG. 1 to FIG. 4 may all be implemented by the processor 502. The processor 502 receives data by using the communications interface 512, and is configured to implement any method performed by the prioritization system in FIG. 1 to FIG. 4. In an implementation process, each step of the processing procedure may be implemented by using an integrated logical circuit of hardware in the processor 502 or an instruction in a form of software, to implement the method performed by the edge device in FIG. 1 to FIG. 4. Program code executed by the processor 502 to implement the foregoing method may be stored in the memory 504.

It should be noted that, it should be understood that division of the modules of the foregoing apparatus is merely division of logical functions, and in actual implementation, all or some modules may be integrated into one physical entity, or may be physically separated. In addition, all of these modules may be implemented in a form of invoking software by a processor element, or all of these modules may be implemented in a form of hardware, or some modules are implemented in a form of invoking software by a processor element, and some modules are implemented in a form of hardware. For example, the receiving module may be a separately disposed processor element, or may be integrated into a chip of the foregoing apparatus for implementation. In addition, the receiving module may alternatively be stored in a memory of the foregoing apparatus in a form of program code, and a processor element of the foregoing apparatus invokes and executes a function of the foregoing receiving module. Implementation of other modules is similar to that of the receiving module. In addition, all or some of these modules may be integrated together, or may be implemented separately. The processor element described herein may be an integrated circuit and has a signal processing capability. In an implementation process, steps in the foregoing methods or the foregoing modules can be implemented by using a hardware integrated logical circuit in the processor element, or by using instructions in a form of software.

For example, the foregoing modules may be one or more integrated circuits configured to implement the foregoing method, for example, one or more application-specific integrated circuits (ASIC), or one or more microprocessors (DSP), or one or more field programmable gate arrays (FPGA), or the like. In another example, when one of the foregoing modules is implemented in a form of invoking program code by a processor element, the processor element may be a general-purpose processor, for example, a central processing unit (CPU) or another processor that can invoke the program code. For another example, the modules may be integrated together and implemented in a form of a system-on-a-chip (SOC).

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Some features in this embodiment of this present disclosure may be implemented/supported by the processor 502 by executing program instructions or software code in the memory 504. Software components loaded on the memory 504 may be summarized from a functional or logical perspective, for example, the receiving module 301, the extracting module 302, the grouping module 303, the adjusting module 304, the calculating module 305, the ranking module 306 and the prioritizing module 307 shown in FIG. 3.

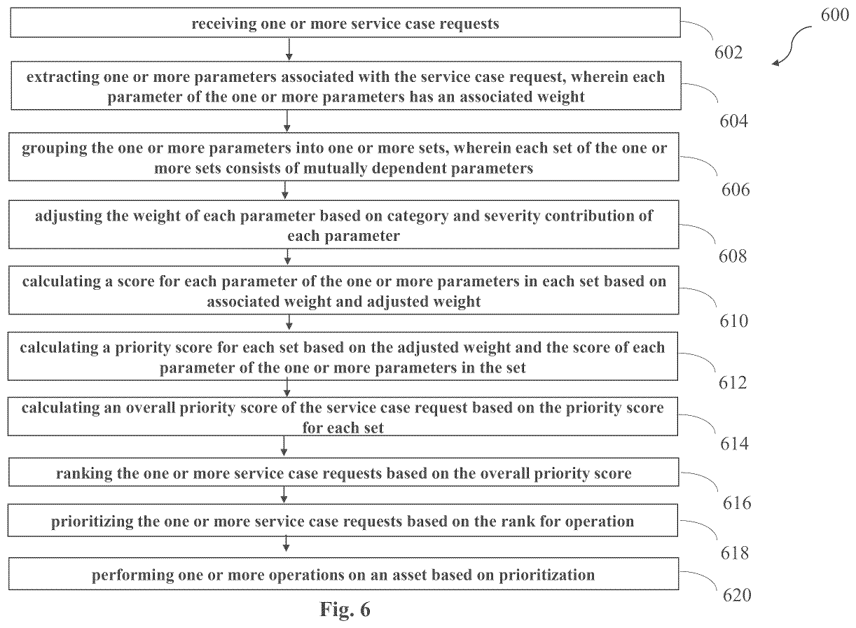

FIG. 6 illustrates an exemplary method for prioritizing service case requests for operation in a prioritization system in accordance with one or more embodiments described herein. The method, 600 may be implemented by the system as described above in FIGS. 1-5. The method 600 is illustrated as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations can be combined in any order and/or in parallel to implement the method.

According to an embodiment, the method 600 may be implemented by one or more processors or modules illustrated and explained through FIGS. 1-5, therefore detailed explanation of the same is omitted here for the sake of brevity.

The method begins at step 602, wherein the method 600 includes receiving one or more service case requests from the one or more industrial plants of an enterprise.

At step 604, the method 600 includes extracting one or more parameters associated with the service case request, wherein each parameter of the one or more parameters has an associated weight and wherein the one or more parameters associated with the one or more service case requests include at least one of: case status, fault last seen, fault duration, fault occurrence, fault last reopened, cost, rule priority, asset priority, impacted space priority of the one or more service case requests.

At step 606, the method 600 includes grouping the one or more parameters into one or more sets, wherein each set of the one or more sets consists of mutually dependent parameter.

At step 608, the method 600 includes adjusting the weight of each parameter based on category and severity contribution of each parameter.

At step 610, the method 600 includes calculating a score for each parameter of the one or more parameters in each set based on associated weight and adjusted weight.

At step 612, the method 600 includes calculating a priority score for each set based on the adjusted weight and the score of each parameter of the one or more parameters in the set.

At step 614, the method 600 includes calculating an overall priority score of the service case request based on the priority score for each set.

At step 616, the method 600 includes ranking the one or more service case requests based on the overall priority score.

At step 618, the method 600 includes prioritizing the one or more service case requests based on the rank.

At step 620, the method 600 includes performing one or more operations on an asset based on prioritization. The one or more operations performed on the asset may be not limited to: repair or replacement of faulty components, adjustment of system settings, maintenance or calibration, software updates or patches, inspection and testing, emergency services, scheduling of maintenance, etc.

In an aspect, the method 600 may further comprises determining the severity contribution of each parameter based on its impact on the overall priority score of each service case request, wherein the category of the one or more parameters is static or dynamic. In an aspect, the method may further comprises updating the overall priority score of the one or more service case requests at scheduled intervals based on one or more dynamic parameters. In an aspect, the method may further comprises updating the rank of the one or more service case requests based on the overall priority score. In an aspect, the method may further comprises prioritizing the one or more service case requests based on the updated rank. In an aspect, the method may further comprises displaying the overall priority score of the one or more service case requests to a user. In an aspect, the method may further comprises manually updating priority of the one or more service case requests.

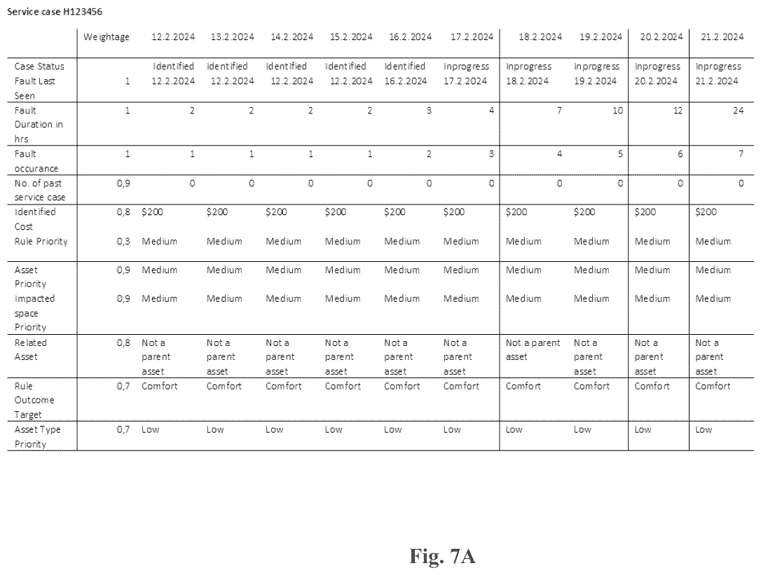

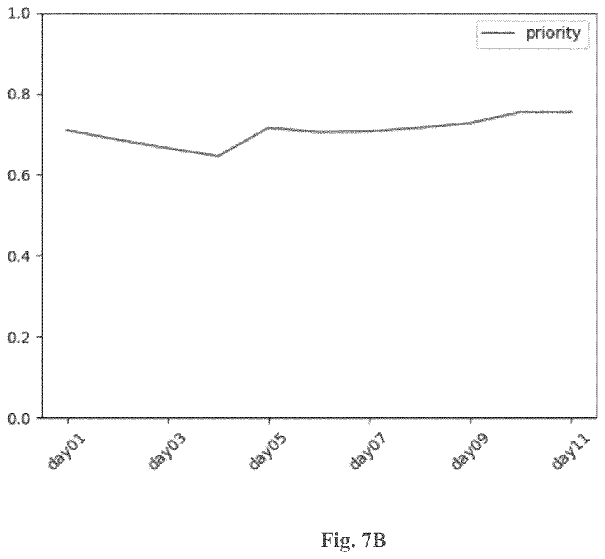

FIGS. 7A and 7B illustrate an exemplary graphical and tabular representation of change in prioritization of a service case request in accordance with one or more embodiments described herein. The overall score priority evolves as shown in FIGS. 7A and 7B, which is driven by increasing fault duration and fault occurrences (both increasing). As can be seen, the prioritization of service case requests changes dynamically in view of changes in the weightage of one or more parameters.

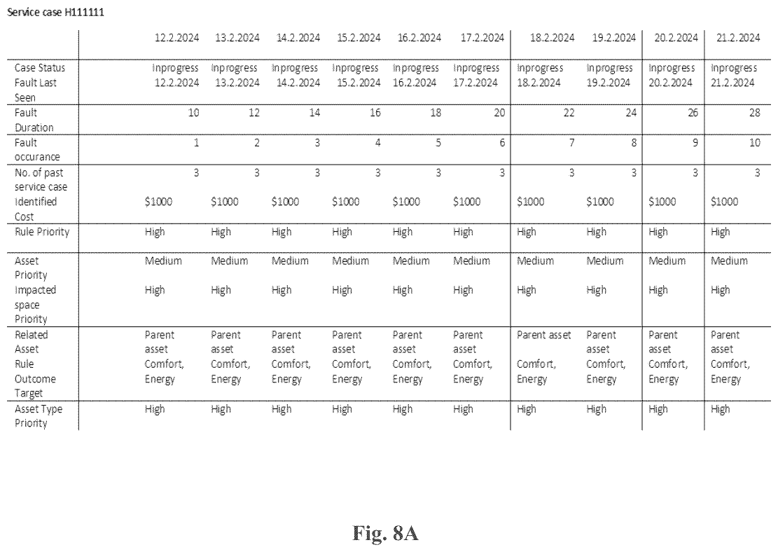

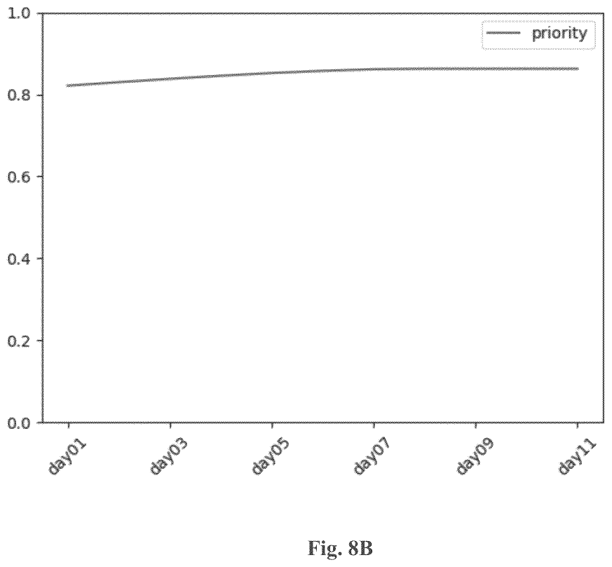

FIGS. 8A and 8B illustrate another exemplary graphical and tabular representation of change in prioritization of a service case request in accordance with one or more embodiments described herein. The corresponding service case request priority starts at 8/10 and quickly reaches almost 10/10 as it corresponds to high-priority rule/space, the increase is also driven by increasing fault duration and fault occurrences.

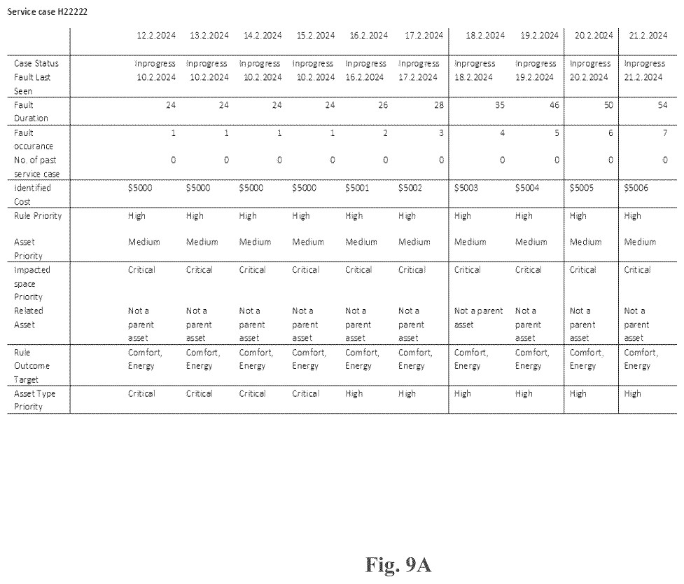

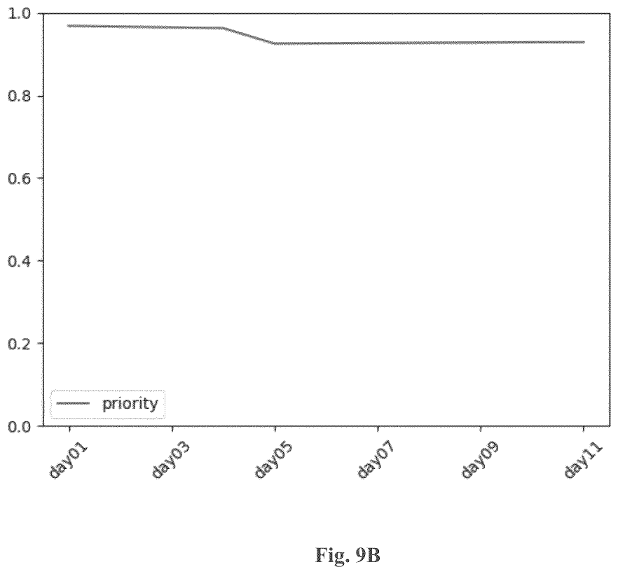

FIGS. 9A and 9B illustrate another exemplary graphical and tabular representation of change in prioritization of a service case request in accordance with one or more embodiments described herein. The corresponding service case request priority is close to 1 since day 1 because of identified cost and high space/asset priority and long fault durations.

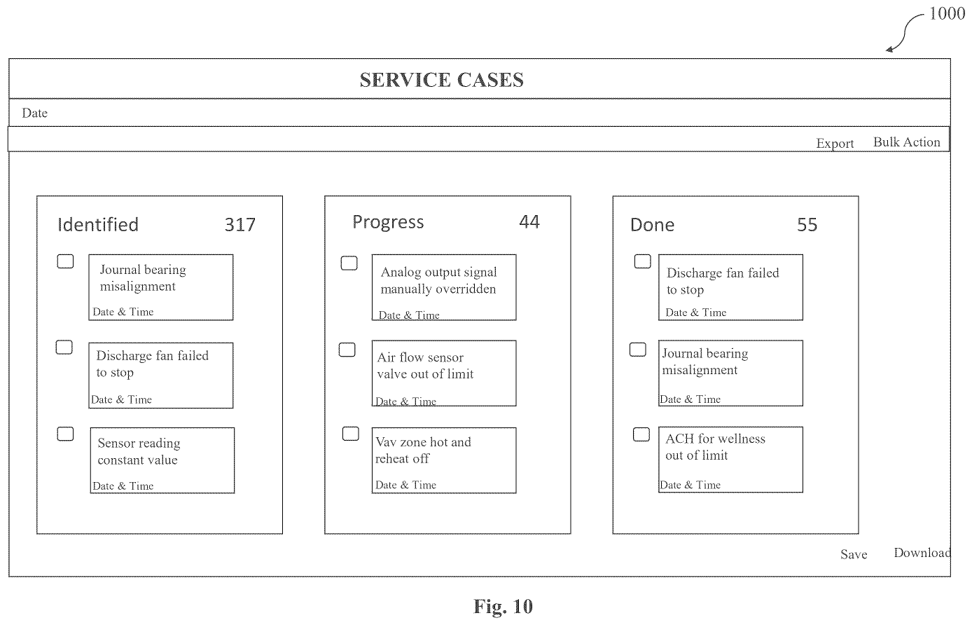

FIG. 10 illustrates an exemplary dashboard layout, in accordance with one or more embodiments described herein. In an embodiment, one or more users 105 and 406 may login to the service case request management system through one or more client devices 102 and 401 to monitor and observe various metrics related to service case requests. In an embodiment, the dashboard layout 1000 may be displayed to the one or more users 105 and 406 which may have drop down list providing the status of service case requests. In an embodiment, the dashboard layout 1000 displays the service case requests that includes the name, data and time of creation of service case requests. In an embodiment, the dashboard layout 1000 displays the service case requests under the tab, “identified”, “progress” and “done” to denote the status of the service case requests. In an embodiment, the dashboard layout 1000 provides the tabs, “date”, “export”, “bulk action”, “save” and “download” to perform one or more operations or actions on the service case requests.

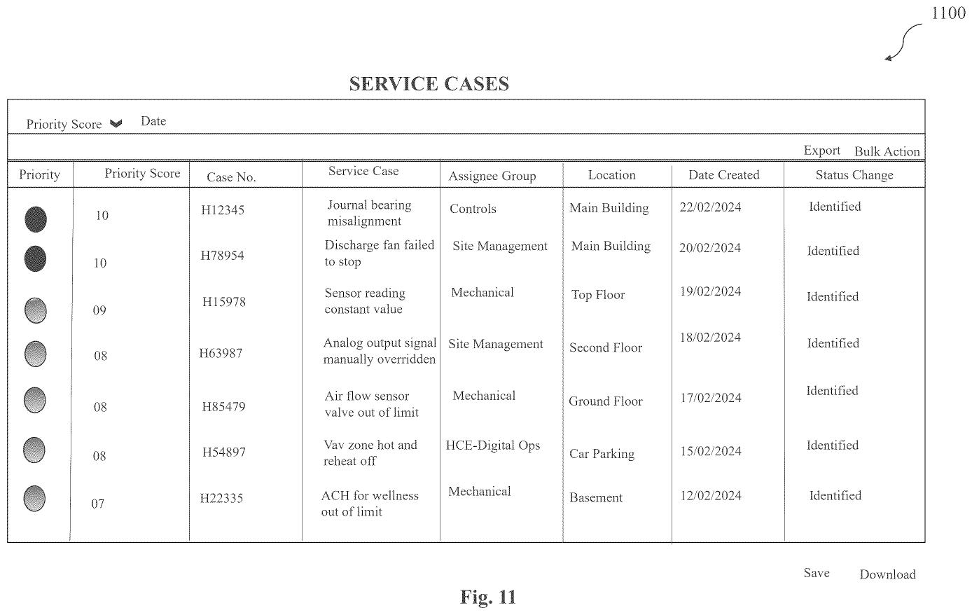

FIG. 11 illustrates another exemplary dashboard layout, in accordance with one or more embodiments described herein. In an embodiment, one or more users 105 and 406 may login to the service case request management system through one or more client devices 102 and 401 to monitor and observe various metrics related to service case requests. In an embodiment, the dashboard layout 1100 may be displayed to the one or more users 105 and 406 which may have drop down list providing the status of service case requests. In an embodiment, the dashboard layout 1100 displays the service case requests that are default sorted by priority score in ascending to descending order with always highest priority service case available on top of the list. As priority score is dynamic in nature page and a refresh is needed to view up to date service case requests list.

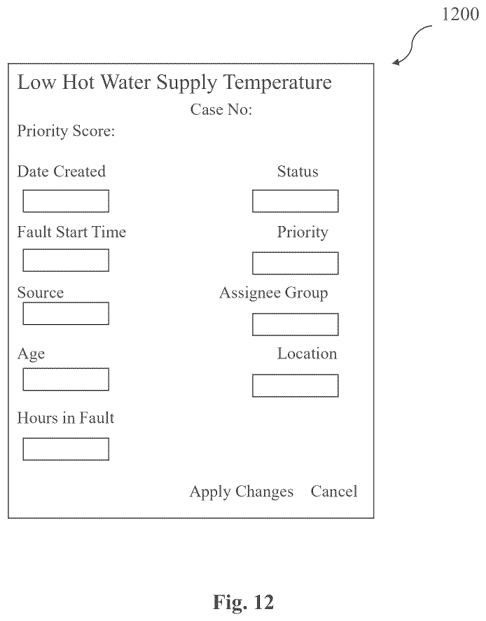

FIG. 12 illustrates another exemplary diagram of a dashboard layout, in accordance with one or more embodiments described herein. In an embodiment, one or more users 105 and 406 may login to the service case request management system through one or more client devices 102 and 401 to monitor and observe various metrics related to service case requests. In an embodiment, the dashboard layout 1200 displays a detailed view of a service case request that includes name, case no., priority score, date created, status, fault start time, priority, source, assignee group, age, location and hours in fault.

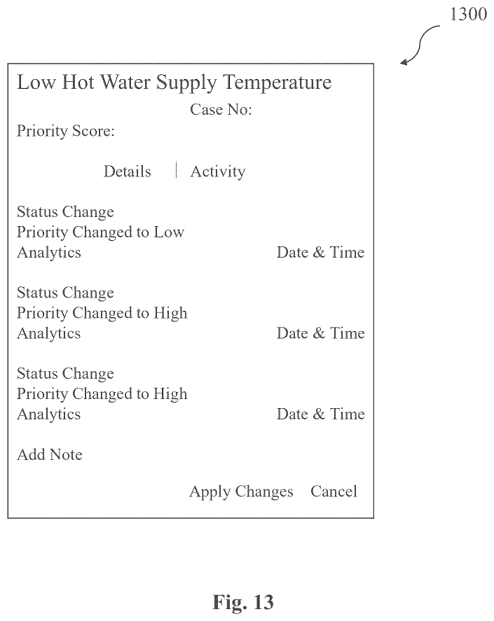

FIG. 13 illustrates another exemplary dashboard layout, in accordance with one or more embodiments described herein. In an embodiment, one or more users 105 and 406 may login to the service case request management system through one or more client devices 102 and 401 to monitor and observe various metrics related to service case requests. In an embodiment, the dashboard layout 1300 displays a service case request detailed view that displays priority score with priority mapped as generated by the system. In an embodiment, the dashboard layout 1300 displays the change in the status of the priority of a service case request in view of dynamic tuning of the priority score over time. Further, page refresh is needed to view up to date priority score of a service case request.

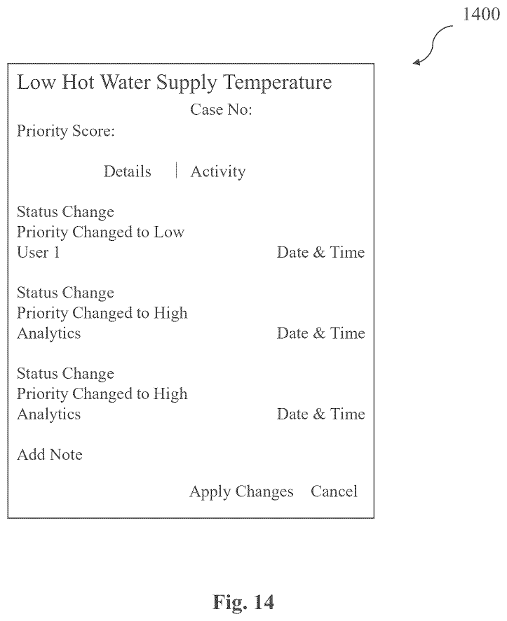

FIG. 14 illustrates another exemplary dashboard layout, in accordance with one or more embodiments described herein. In an embodiment, one or more users 105 and 406 may login to the service case request management system through one or more client devices 102 and 401 to monitor and observe various metrics related to service case requests. In an embodiment, the dashboard layout 1400 displays a service case request detailed view that displays priority score with priority mapped. In an embodiment, the dashboard layout 1400 displays the change in the status of the priority of a service case request, which was manually edited by the one or more users 105 and 406. In an embodiment, the dashboard layout 1400 may displays the change in the status of the priority of a service case request. In an embodiment, the dashboard layout 1400 displays the change in the status of the priority of a service case request in view of dynamic tuning of the priority score over time.

Embodiments of the present disclosure may provide an efficient system and method for prioritizing one or more service case requests based on one or more parameters associated with each service case request. The disclosed techniques streamline the prioritization service by reducing costs, optimizing resources, effective management, thereby providing enhanced system performance.

The disclosed system and method may also leverage the possibility of using Artificial intelligence (AI) models to implement the various functionalities disclosed herein. The AI models may be utilized to prioritize the one or more service case request in a prioritization system efficiently.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments, a storage system or other management entity within the artificial intelligence and machine learning infrastructure may also implement automated training with continuous learning based on new data.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1. A method for prioritizing service case requests, comprising:
receiving one or more service case requests;
wherein for each service case request of the one or more service case requests:
extracting one or more parameters associated with the service case request, wherein each parameter of the one or more parameters has an associated weight;
grouping the one or more parameters into one or more sets, wherein each set of the one or more sets consists of mutually dependent parameters;
adjusting the weight of each parameter based on category and severity contribution of each parameter;
calculating a score for each parameter of the one or more parameters in each set based on associated weight and adjusted weight;
calculating a priority score for each set based on the adjusted weight and the score of each parameter of the one or more parameters in the set;
calculating an overall priority score of the service case request based on the priority score for each set;
ranking the one or more service case requests based on the overall priority score;
prioritizing the one or more service case requests based on the rank; and
performing one or more operations on an asset based on prioritization.

2. The method of claim 1, wherein the one or more parameters associated with the one or more service case requests include at least one of: case status, fault last seen, fault duration, fault occurrence, fault last reopened, cost, rule priority, asset priority, impacted space priority of the one or more service case requests.

3. The method of claim 1, further comprising:
determining the severity contribution of each parameter based on its impact on the overall priority score of each service case request.

4. The method of claim 1, wherein the category of the one or more parameters is static or dynamic.

5. The method of claim 4, further comprising:
updating the overall priority score of the one or more service case requests at scheduled intervals based on one or more dynamic parameters.

6. The method of claim 5, further comprising:
updating the rank of the one or more service case requests based on the overall priority score.

7. The method of claim 6, further comprising:
prioritizing the one or more service case requests based on the updated rank.

8. The method of claim 1, further comprising:
displaying the overall priority score of the one or more service case requests to a user.

9. The method of claim 1, further comprising:
manually updating priority of the one or more service case requests.

10. A system for prioritizing service case requests, comprising:
a memory; and
at least one processor coupled to the memory and configured to:
receive one or more service case requests;
wherein for each service case request of the one or more service case requests, the at least one processor is configured to:
extract one or more parameters associated with the service case request, wherein each parameter of the one or more parameters has an associated weight;
group the one or more parameters into one or more sets, wherein each set of the one or more sets consists of mutually dependent parameters;
adjust the weight of each parameter based on category and severity contribution of each parameter;
calculate a score for each parameter of the one or more parameters in each set based on associated weight and adjusted weight;
calculate a priority score for each set based on the adjusted weight and the score of each parameter of the one or more parameters in the set;
calculate an overall priority score of the service case request based on the priority score for each set;
rank the one or more service case requests based on the overall priority score;
prioritize the one or more service case requests based on the rank; and
perform one or more operations on an asset based on prioritization.

11. The system of claim 10, wherein the one or more parameters associated with the one or more service case requests include at least one of: case status, fault last seen, fault duration, fault occurrence, fault last reopened, cost, rule priority, asset priority, impacted space priority of the one or more service case requests.

12. The system of claim 10, wherein the at least one processor is configured to:
determine the severity contribution of each parameter based on its impact on the overall priority score of each service case request.

13. The system of claim 10, wherein the category of the one or more parameters is static or dynamic.

14. The system of claim 13, wherein the at least one processor is configured to:
update the overall priority score of the one or more service case requests at scheduled intervals based on one or more dynamic parameters.

15. The system of claim 14, wherein the at least one processor is configured to:
update the rank of the one or more service case requests based on the overall priority score.

16. The system of claim 15, wherein the at least one processor is configured to:
prioritize the one or more service case requests based on the updated rank.

17. The system of claim 10, wherein the at least one processor is configured to:
display the overall priority score of the one or more service case requests to a user.

18. The system of claim 10, further comprising a user interface for manually updating the priority of the one or more service case requests.

19. A non-transitory computer readable storage medium storing program instructions for prioritizing service case requests, the program instructions when executed, perform the steps of:
receiving one or more service case requests;
wherein for each service case request of the one or more service case requests,
extracting one or more parameters associated with the service case request, wherein each parameter of the one or more parameters has an associated weight;
grouping the one or more parameters into one or more sets, wherein each set of the one or more sets consists of mutually dependent parameters;
adjusting the weight of each parameter based on category and severity contribution of each parameter;
calculating a score for each parameter of the one or more parameters in each set based on associated weight and adjusted weight;
calculating a priority score for each set based on the adjusted weight and the score of each parameter of the one or more parameters in the set;
calculating an overall priority score of the service case request based on the priority score for each set;
ranking the one or more service case requests based on the overall priority score;
prioritizing the one or more service case requests based on the rank; and
performing one or more operations on an asset based on prioritization.

20. The non-transitory computer-readable storage medium of claim 19, the instructions, when executed, perform the steps of:
determining the severity contribution of each parameter based on its impact on the overall priority score of each service case request.
